(19) United States
(12) Patent Application Publication
(10) Pub. No.: US 2022/0233895 A1
(43) Pub. Date: Jul. 28, 2022

(54) MASK SHEET AND MASK

(71) Applicant: MEDICAL-AID CO., LTD., Izumi-shi, Osaka (JP)

(72) Inventor: Hideki MATSUI, Izumi-shi, Osaka (JP)

(73) Assignee: MEDICAL-AID CO., LTD., Izumi-shi, Osaka (JP)

(21) Appl. No.: 17/617,765

(22) PCT Filed: Oct. 19, 2020
(86) PCT No.: PCT/JP2020/039301

§ 371 Date: Dec. 9, 2021

(30) Foreign Application Priority Data
Feb. 28, 2020 (JP) 2020-000699
Jun. 30, 2020 (JP) 2020-113219

(51) Int. Cl. A62B 18/02; A41D 13/11; A41D 27/28; A41D 31/04; D04B 21/12; D06M 11/83; D06M 16/00

(52) U.S. Cl. CPC A62B 18/02; A41D 13/113; A41D 13/1161; A41D 13/1192; D10B 2401/13; A41D 31/04; D04B 21/12; D06M 11/83; D06M 16/00; A41D 27/28

(57) ABSTRACT

A mask sheet is provided. The mask sheet is a mesh sheet in which twisted yarns are knitted into a mesh shape, the twisted yarns being provided by twisting filaments each of which is formed by coating a synthetic fiber with silver. A stitch opening of the mesh sheet may be 1 mm or more. The mesh sheet may be a tricot-knitted sheet.

### TECHNICAL FIELD

The present invention relates to a mask sheet and a mask.

### BACKGROUND ART

In the related art, a mask is used, for example, to prevent infection of viruses such as influenza and pathogenic bacteria in medical facilities and cities, and to prevent pollen and dust in an environment where there are many pollen and dust. Further, the mask is also used in a site where hygiene is required, such as a food manufacturing and processing factory, and in a site where odor is generated, such as a cleaning site and a waste water treatment facility. As described above, a usage mode of the mask is diverse.

Various masks are known. For example, Patent Literature 1 discloses a mask in which a sheet-shaped body made of fibrous cellulose that supports a metal such as silver and a deodorant layer or the like are overlapped and sandwiched between nonwoven fabric layers by bringing a metal compound aqueous solution into contact with fine fibrous cellulose having a phosphoric acid group.

### CITATION LIST

### Patent Literature

Patent Literature 1: JP-A-2020-2483

### SUMMARY OF INVENTION

### Technical Problem

Incidentally, the sheet-shaped body including the fibrous cellulose described in Patent Literature 1 is excellent in an ability to capture a functional substance, but is required to further improve performance of the mask.

### Solution to Problem

In order to solve the above-described problems, the present invention provides the following mask sheet and mask.

(1) A mask sheet,

in which the mask sheet is a mesh sheet in which twisted yarns are knitted into a mesh shape, the twisted yarn being provided by twisting filaments each of which is formed by coating a synthetic fiber with silver.

(2) The mask sheet according to the above (1),

in which a stitch opening of the mesh sheet is 1 mm or more.

(3) The mask sheet according to the above (1) or (2),

in which the mesh sheet is a tricot-knitted sheet.

(4) A mask for covering a peripheral portion of a mouth and nostrils of a wearer,

in which the mask includes a nonwoven fabric sheet, the mask sheet according to any one of the above (1) to (3), and a mask main body portion in this order from a face side of the wearer,

in which the mask main body portion includes a mesh material having a stitch opening of 1 mm or more, a fabric cloth sewn to the mesh material so as to open a central portion of the mesh material such that a first ventilation portion is formed by the central portion of the mesh material, and a pair of ear straps for fixing the mask main body portion to ears of the wearer, and

in which the mask sheet is overlapped with the first ventilation portion.

(5) The mask according to (4),

in which the fabric cloth is sewn to the mesh material so as to open lateral portions of the mesh material to form a pair of second ventilation portions by the lateral portions of the mesh material adjacent to the first ventilation portion in a left-right direction, and

in which the second ventilation portions are located on left and right outer sides of left and right end portions of the nonwoven fabric sheet.

(6) The mask according to (5),

in which the fabric cloth includes a pair of band pieces that are sewn to the mesh material and separate the first ventilation portion and the second ventilation portions.

(7) The mask according to any one of (4) to (6),

in which the nonwoven fabric sheet having a rectangular shape is larger than the mask sheet having a rectangular shape, and

in which the fabric cloth includes an upper band portion and a lower band portion which are sewn to the mesh material so as to form an opening to sandwich the nonwoven fabric sheet between the mesh material and the fabric cloth.

(8) The mask according to any one of (4) to (7), further including:

a double-sided tape that fixes the nonwoven fabric sheet and the mask sheet by one surface and that fixes the nonwoven fabric sheet and the mask sheet to the mask main body portion by the other surface.

(9) A mask for covering a peripheral portion of a mouth and nostrils of a wearer,

in which the mask includes a nonwoven fabric sheet, the mask sheet according to any one of the above (1) to (3), and a mask main body portion in this order from a face side of the wearer,

in which the mask main body portion includes an outside cloth, a fabric cloth having an upper band portion and a lower band portion sewn to the outside cloth so as to form a first ventilation portion by a central portion of the outside cloth and to vertically include an opening for sandwiching the nonwoven fabric sheet between the fabric cloth and the outside cloth, and a pair of ear straps for fixing the mask main body portion to ears of the wearer, and

in which the mask sheet is overlapped with the first ventilation portion.

(10) A mask main body portion for a mask for covering a peripheral portion of a mouth and nostrils of a wearer in cooperated together with the mask sheet according to any one of the above (1) to (3) and a nonwoven fabric sheet, the mask main body portion including:

a mesh material having a stitch opening of 1 mm or more;

a fabric cloth sewn to the mesh material to form a first ventilation portion in a central portion of the mesh material; and

a pair of ear straps for fixing the mask main body portion to ears of the wearer.

(11) A mask including:

a mask main body portion including the mask sheet according to any one of the above (1) to (3); and

a fixing portion connected to the mask main body portion and configured to fix the mask main body portion to a lower portion of a face of a wearer.

(12) The mask according to (11),

in which the mask main body portion includes a pocket portion for inserting the mask sheet.

### Advantageous Effects of Invention

According to the mask sheet of the present invention, a surface area of silver that constitutes the mesh sheet can be greatly increased, and disinfection, sterilization, anti-bacteria, or deodorization can be performed more effectively.

According to the mask of the present invention, the nonwoven fabric sheet prevents droplets from the wearer, silver ions contained in a silver filter exhibit excellent disinfection, sterilization, anti-bacteria, and deodorization effects, and in the mask main body portion, since the peripheral portion of a mouth and nostrils of the wearer is covered with the mesh material, the mask main body portion is excellent in air permeability and heat dissipation. Therefore, performance of the mask is more excellent, and the mask can also be favorably used for applications requiring the air permeability, particularly, use under a high temperature such as summer. Further, the silver filter and the mask main body portion can be cleaned and repeatedly used, which is economical.

According to the mask of the present invention, the nonwoven fabric sheet prevents droplets from the wearer, the silver ions contained in the silver filter exhibit excellent disinfection, sterilization, anti-bacteria, and deodorization effects, and the mask main body portion sandwiches the nonwoven fabric sheet between the upper and lower openings, so that the nonwoven fabric sheet and the silver filter can be easily incorporated. Therefore, performance of the mask is more excellent, and the silver filter and the mask main body portion can be cleaned and repeatedly used, which is economical.

### BRIEF DESCRIPTION OF DRAWINGS

FIG. 1 is a schematic plan view showing a tricot-knitted mesh sheet as a mask sheet of the present invention.

FIG. 2 is a schematic plan view showing a tulle-knitted mesh sheet as another example of the mask sheet of the present invention.

FIG. 3 is a view showing an example of a mask of the present invention, and is a plan view seen from a face side of a wearer.

FIG. 4 is a cross-sectional view taken along a line A-A of FIG. 3.

FIG. 5 is a plan view of a mask main body portion when viewed from the face side of the wearer.

FIG. 6 is an enlarged view of a mesh material of the mask main body portion.

FIG. 7 is a development view of the mesh material and a fabric cloth of the mask main body portion.

FIG. 8 is an explanatory view of a method of attaching a silver filter to the nonwoven fabric sheet.

FIG. 9 is a plan view of a mask of a modification of the present invention when viewed from the face side of the wearer.

FIG. 10 is a perspective view showing another modification of the mask of the present invention.

FIG. 11 is a perspective view showing still another modification of the mask of the present invention.

FIG. 12 is a graph showing a silver concentration when the mask sheet of the present invention is put into ultrapure water.

### DESCRIPTION OF EMBODIMENTS

Hereinafter, the present invention will be described in detail with reference to the drawings, but the present invention is not limited to the following embodiment.

(Mask Sheet)

A mask sheet 20 of the present invention is a mesh sheet provided by knitting a twisted yarn 21 in a mesh shape, the twisted yarn 21 being provided by twisting a plurality of filaments formed by coating synthetic fibers with silver. Examples of the synthetic fibers can include polyester fibers, polyolefin fibers, nylon fibers, and acrylic resin fibers. Further, if the number of the synthetic fibers is too small, strength and durability are insufficient, and if the number is too large, flexibility and plasticity are insufficient, so that the number of twisted synthetic fibers is suitably 5 to 20.

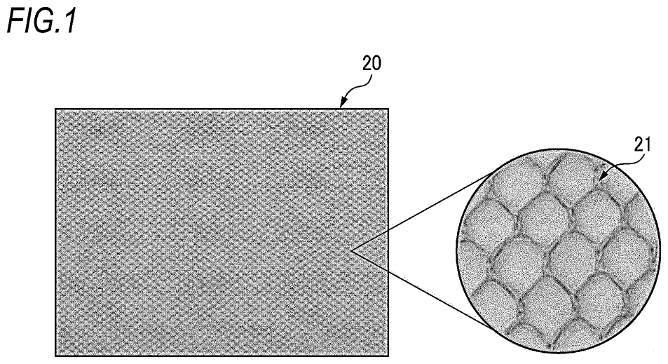

As a knitting method of the twisted yarn 21, warp knitting is preferable because of excellent stretchability, and for example, tricot knitting can be exemplified. FIG. 1 is a plan view showing a tricot-knitted mask sheet 20, in which the twisted yarn 21 provided by twisting the plurality of silver-coated filaments is knitted in a hexagonal shape.

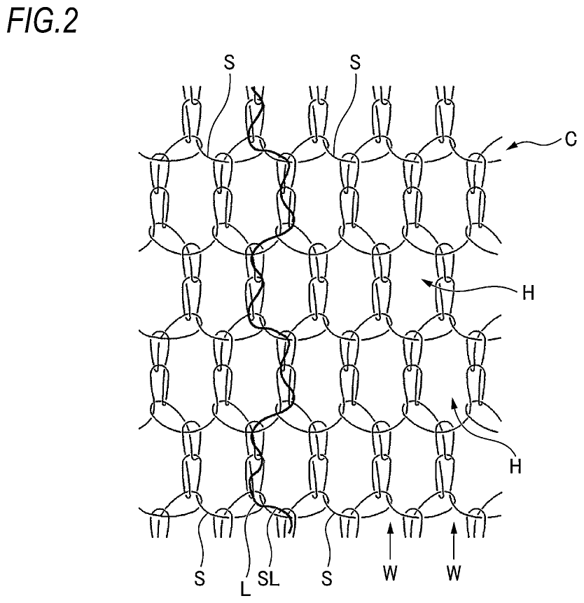

As another example of the warp knitting, tulle knitting as shown in FIG. 2 can be exemplified. In the shown tulle knitting, all yarns are passed through a guide of a sley to knit a mesh-shaped tulle structure C. At this time, a stitch H having a substantially regular hexagonal shape is formed from a wales W to a wales W through a sinker loop S. Further, an insertion yarn L may be used to form two knitting yarns SL at a position of one sinker loop S.

A size of the stitch when knitting in a mesh shape, that is, an opening is preferably 1 mm or more. A shape of the stitch is preferably a substantially regular hexagonal shape in terms of strength, and in this case, a diameter is 1 mm or more in terms of an equivalent circle diameter. When the opening is less than 1 mm, air permeability is poor. An upper limit of the opening is suitably 3 mm or less because if the stitch is too coarse, an antibacterial effect, a deodorant effect, and the like, which will be described later, may not be sufficiently provided. The shape of the stitch is not limited to the substantially regular hexagonal shape, and may be a polygonal shape including a rectangle or a parallelogram depending on shaping.

Although silver generates silver ions, the silver ions are unstable and positively charged. Therefore, the silver ions adhere to a cell wall of bacterium in association with oxygen of the bacterium negatively charged, and the cell wall is destroyed and killed (sterilization action). Further, although a cell wall is not destroyed in a bacterium having a strong cell wall, if positive ions adhere to the cell wall, protein synthesis is inhibited, division is not possible, and proliferation of the bacterium is prevented. Furthermore, the silver ions decompose water into hydroxyl radicals and hydrogen radicals as a catalyst, and the hydroxyl radicals are taken into a virus or a bacterium to destroy a cell wall. Therefore, a sterilization effect and an antibacterial effect can be expected for a wide range of viruses and bacteria.

The silver ions also have a deodorant action. Since the silver ions prevent proliferation of various bacteria, putrid odor caused by the various bacteria is prevented. Further, by adsorbing negatively charged malodorous molecules, oxidative decomposition is performed to prevent body odor caused by malodorous molecules from a perspiratory gland and a sebaceous gland and proliferation of bacterium.

Pollen and house dust (allergens) are both positively and negatively charged, but since the silver ions are positively charged, the positively charged allergen repels, and the negatively charged allergen is adsorbed to suppress an activity thereof.

The silver has these effects, and the silver is used for tableware or the like, is used for a medicine such as a sterilizer, a nasal agent, eye drops, and the like, and it is considered that there is almost no evidence that indicates toxicity in a normal clinical test, the silver is also not carcinogenic, and safety is also high.

Further, silver is easily ionized by chlorine. Since exhaled air and saliva of human also contain chlorine, silver is easily ionized in the mask. Further, since tap water contains a small amount of chlorine, when washed with water, the silver is ionized to exhibit a sterilization action or a deodorant action, and the mask sheet of the present invention can be repeatedly used many times only by washing with water.

The coating with the silver is preferably performed on an entire surface of the fiber, but may be performed on a part of the fiber. The larger a coating amount of silver is, the more the effect described above can be provided, but even when the coating amount is excessive, not only the effect is saturated, but also a cost is increased. Specifically, in a mass ratio, filament (fiber amount):silver is preferably 60:40 to 80:20. Further, as a coating method, electroless plating is easy and preferable.

As described above, in the mask sheet 20 of the present invention, since a surface area of the silver is greatly increased, an amount of the silver ions generated and a time during which a silver ion concentration is increased can be shortened, and disinfection, sterilization, anti-bacteria, or deodorization can be more effectively performed. Further, since antibacterial properties of the mask sheet 20 do not deteriorate even when the mask sheet 20 is washed, the mask sheet 20 can be repeatedly used many times, and the effect of generating the silver ions can be maintained for a long period of time.

In order to verify the sterilization effect of the silver, the following test was performed. The test was performed as follows in the Judicial Foundation, the Biological Testing Center of the Japan Chemical Fiber Inspection Association.

(Test Product)

A twisted yarn of a filament provided by electroless plating the silver on a surface of nylon was tricot-knitted in a honeycomb shape to provide a test product (MG net 100: manufactured by Medical Aid Co., Ltd). A coating amount of silver of the filament was 70% by mass of nylon and 30% by mass of silver, a size of the test product was 90 mm in width×70 mm in height×0.2 mm in thickness, and a silver surface area was 0.5 m² or more. Further, an opening was 1.0 mm, a diameter of the twisted yarn was 0.2 mm, and a diameter of one fiber was 0.02 mm (in a case of 12 filaments), and in this case, a surface area of the silver was 300 times or more a sheet area.

(Test Institution)

Judicial Foundation, Biological Testing Center of Japan Chemical Fiber Inspection Association

(Test Content)

Antibacterial properties and sterilizing properties (unified test method)

(Outline of Test)

Based on the unified test method, a test product and a nylon standard white cloth without silver coating were immersed in a culture solution, the same number of various viable bacteria were inoculated therein, and the number of viable bacteria after 18 hours was inspected. When the number of viable bacteria is counted, the culture solution is diluted 20 times, and when the number of viable bacteria is 0, the display indicates that the number of viable bacteria is 20 or less.

Further, based on a high-temperature accelerated washing method (JIS L 0217, 103, using a JAFET standard detergent), the number of viable bacteria was also inspected when the same test was performed after washing was performed 10 times and 50 times.

(Test Bacterial Species)

Staphylococcus aureus ATCC 6538P, Klebsiella pneumoniae ATCC 4352, MRSA Methicillin Resistant Staphylococcus aureus ID 1677, Escherichia coli O157:H7 ATCC 43888, Pseudomonas aeruginosa NBRC 3080, (Bacterial culture medium)

Luria broth (10 g of tryptone, 5 g of yeast extract, and 0.5 g of salt were dissolved in 1 liter of water).

Test results are as follows.

TABLE 1
1) Staphylococcus aureus

| | | the number | bacteriostatic | sterilization |
|---|---|---|---|---|
| | | of viable | activity | activity |
| sample | | bacteria | value | value |
| test | (original product) | 20 or less | 5.8 or more | 3.1 or more |
| product | (after 10 times | 20 or less | 5.8 or more | 3.1 or more |
| | of washing) | | | |
| | (after 50 times | 20 or less | 5.8 or more | 3.1 or more |
| | of washing) | | | |
| nylon | (immediately after | 2.5 × 10⁴ | | |
| standard | inoculation ) | | | |
| white | (18 hours after | 1.2 × 10⁷ | | |
| cloth | inoculation) | | | |

TABLE 2
2) Klebsiella pneumonia

| | | the number | bacteriostatic | sterilization |
|---|---|---|---|---|
| | | of viable | activity | activity |
| sample | | bacteria | value | value |
| test | (original product) | 20 or less | 6.1 or more | 3.0 or more |
| product | (after 10 times | 20 or less | 6.1 or more | 3.0 or more |
| | of washing) | | | |
| | (after 50 times | 20 or less | 6.1 or more | 3.0 or more |
| | of washing) | | | |
| nylon | (immediately after | 2.2 × 10⁴ | | |
| standard | inoculation ) | | | |
| white | (18 hours after | 2.4 × 10⁷ | | |
| cloth | inoculation) | | | |

TABLE 3
3) MRSA

| | | the number | bacteriostatic | sterilization |
|---|---|---|---|---|
| | | of viable | activity | activity |
| sample | | bacteria | value | value |
| test | (original product) | 20 or less | 5.6 or more | 3.0 or more |
| product | (after 10 times | 4.0 × 10 | 5.3 | 2.6 |
| | of washing) | | | |
| | (after 50 times | 1.2 × 10⁴ | 2.9 | 0.2 |
| | of washing) | | | |
| nylon | (immediately after | 1.8 × 10⁴ | | |
| standard | inoculation ) | | | |
| white | (18 hours after | 8.7 × 10⁸ | | |
| cloth | inoculation) | | | |

TABLE 4
4) Escherichia coli

| | | the number | bacteriostatic | sterilization |
|---|---|---|---|---|
| | | of viable | activity | activity |
| sample | | bacteria | value | value |
| test | (original product) | 20 or less | 5.9 or more | 3.0 or more |
| product | (after 10 times | 20 or less | 5.9 or more | 3.0 or more |
| | of washing) | | | |
| | (after 50 times | 20 or less | 5.9 or more | 3.0 or more |
| | of washing) | | | |
| nylon | (immediately after | 2.0 × 10⁴ | | |
| standard | inoculation ) | | | |
| white | (18 hours after | 1.7 × 10⁷ | | |
| cloth | inoculation) | | | |

TABLE 5
5) Pseudomonas aeruginosa

| | | the number | bacteriostatic | sterilization |
|---|---|---|---|---|
| | | of viable | activity | activity |
| sample | | bacteria | value | value |
| test | (original product) | 20 or less | 6.0 or more | 3.0 or more |
| product | (after 10 times | 20 or less | 6.0 or more | 3.0 or more |
| | of washing) | | | |
| | (after 50 times | 20 or less | 6.0 or more | 3.0 or more |
| | of washing) | | | |
| nylon | (immediately after | 2.2 × 10⁴ | | |
| standard | inoculation ) | | | |
| white | (18 hours after | 2.1 × 10⁷ | | |
| cloth | inoculation) | | | |

In the SEK standard (standard of the Japanese Association for the Functional Evaluation of Textiles), a bacteriostatic activity value is 2.2 or more, and antibacterial properties are considered to be good, as is clear from the above Tables 1 to 5. In the test product according to the present invention, not only the bacteriostatic activity value but also a sterilization activity value is at the highest level.

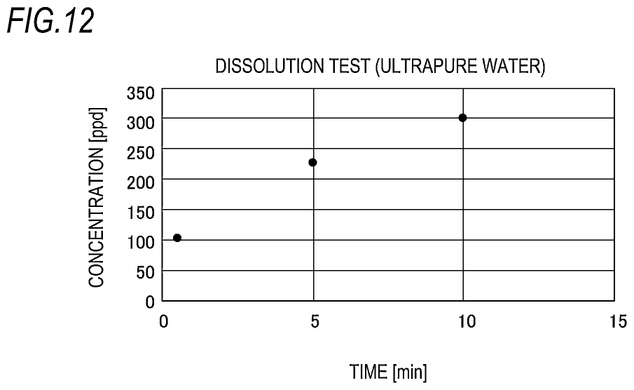

Next, when 5 g of the test product (the MG net 100: manufactured by Medical Aid Co., Ltd) that is a material of the mask sheet was put into 1 liter of ultrapure water, a generation state of a silver concentration (silver ion amount) was inspected. The test was performed at the Osaka Research Institute of Industrial Science and Technology (Headquarters, Izumi Center). Test results are shown in FIG. 12.

As a result, it was confirmed that the silver ion concentration exceeded 100 ppb (0.1 ppm) in 1 minute after the test product was put into the ultrapure water. Therefore, although a weight of the mask sheet is 0.1 g, when the test product is used in the mask, silver ions are generated by reacting with moisture of exhaled air in a short time, a concentration of the silver ions contained in the exhaled air in the mask is increased, and disinfection, anti-bacteria, and deodorization in the mask and an allergic substance prevention effect of the pollen are exerted. Further, since the exhaled air containing the silver ions in the mask is discharged to an outside from a gap of the mask, the disinfection, the anti-bacteria, and the deodorization and the allergic substance prevention effect of the pollen are exerted on a periphery of the mask and also eyes. Therefore, the mask sheet can be expected to have an effect of preventing droplet infection and air infection.

Therefore, according to the mask sheet 20 of the present embodiment, the surface area of the silver that constitutes the mesh sheet can be greatly increased, and the disinfection, the sterilization, the anti-bacteria, or the deodorization can be performed more effectively.

(Mask)

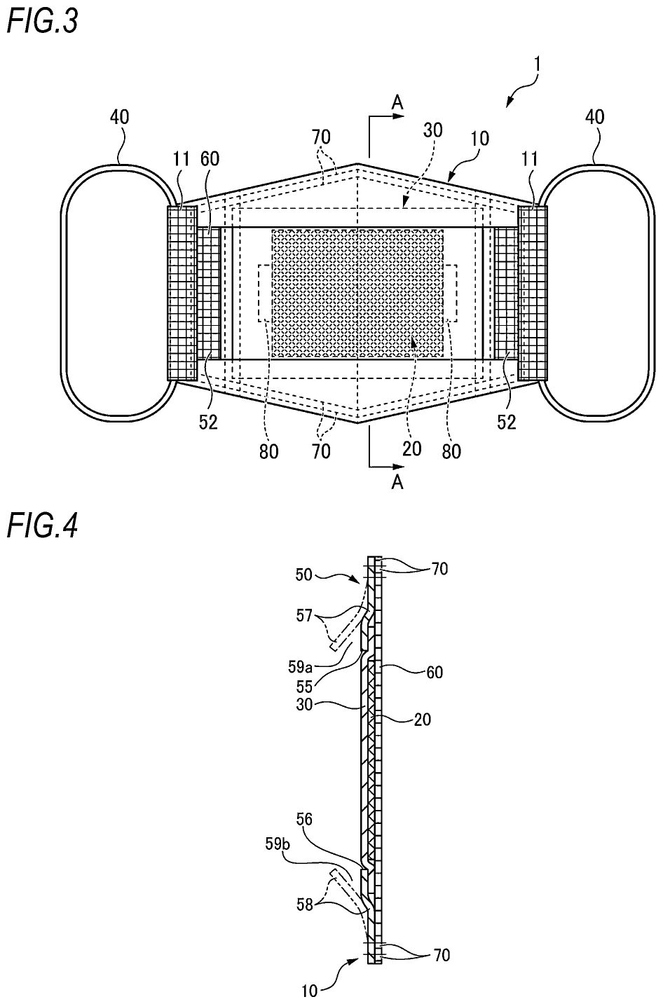

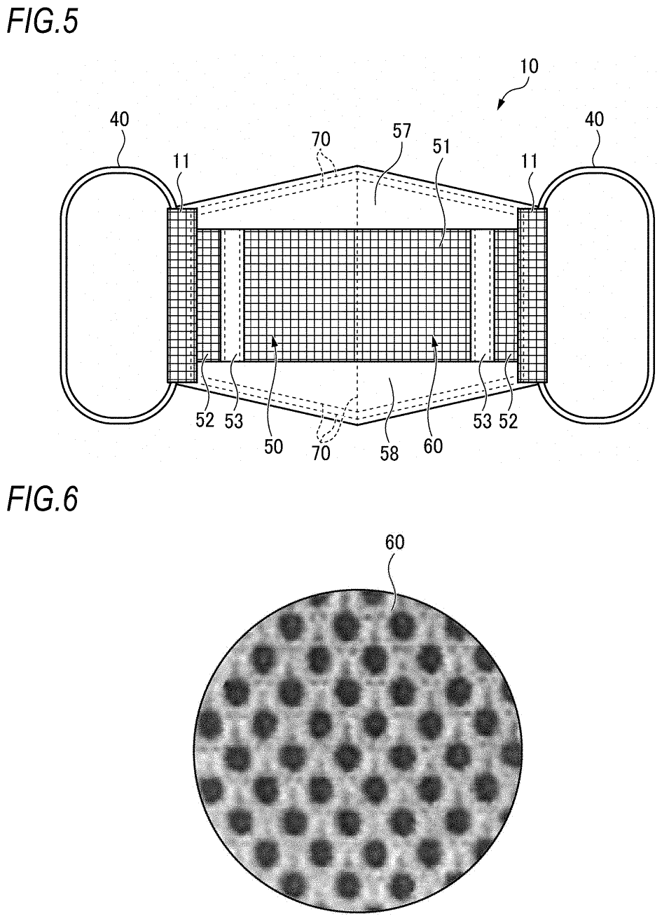

FIG. 3 is a view showing an example of the mask of the present embodiment, and is a plan view seen from a face side of a wearer. Further, FIG. 4 is a cross-sectional view taken along a line A-A of FIG. 3. FIG. 5 is a plan view of a mask main body portion 10 when viewed from the face side. In the present description, an upper-lower direction (vertical direction) and a left-right direction (horizontal direction) represent directions in a state where the mask is worn.

A mask 1 of the present embodiment includes the mask main body portion 10, the rectangular mask sheet 20 described above, and a rectangular nonwoven fabric sheet 30. Further, the mask 1 is worn by arranging the nonwoven fabric sheet 30, the mask sheet 20, and the mask main body portion 10 in this order from the face side of the wearer.

As also shown in FIG. 5, the mask main body portion 10 is formed by sewing a fabric cloth 50 and a mesh material 60 that covers an entire surface of the atmosphere side, and a reference numeral 70 in the drawing denotes a sewing trace. Since the fabric cloth 50, which is an inside cloth, is in contact with a nose, cheeks, and a jaw of the wearer, the fabric cloth 50 is preferably made of cotton in consideration of attachment properties. Further, the mesh material 60, which is an outside cloth, is preferably made of a synthetic resin such as polyester in consideration of durability. The mask main body portion 10 has a substantially horizontally long hexagonal shape, but is not limited thereto.

FIG. 6 is an enlarged view of the mesh material 60, and in order to enhance the air permeability, openings that are portions shown in black in the drawing are 1 mm or more, and preferably 2 mm or more. Since the mask 1 includes the mask sheet 20 described later, even when the openings of the mesh material 60 are increased to 1 mm or more, a function as a mask can be favorably provided. A shape of the stitch is preferably a substantially regular hexagonal shape in terms of strength, and in this case, a diameter is 1 mm or more in terms of an equivalent circle diameter. An upper limit of the opening is suitably 5 mm or less from a viewpoint of strength. The shape of the stitch is not limited to the substantially regular hexagonal shape, and may be a polygonal shape including a rectangle or a parallelogram depending on shaping.

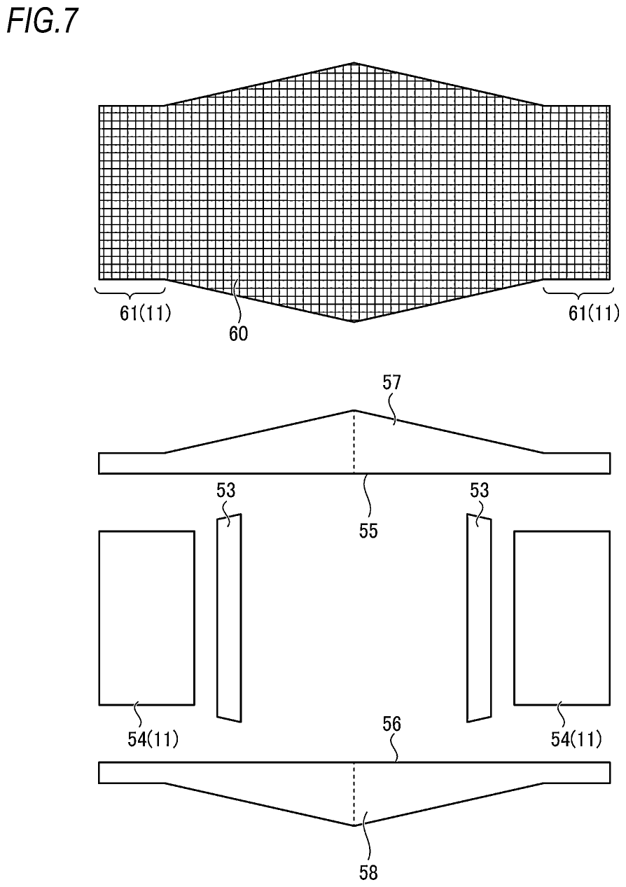

As also shown in FIGS. 5 and 7, the fabric cloth 50 includes an upper band portion 57 and a lower band portion 58 that respectively have shapes of an upper portion and a lower portion of the mask main body portion 10 and that respectively extend horizontally upward and downward, a pair of band pieces 53 and 53 that extend in the upper-lower direction at positions on left and right outer sides of left and right end portions of the mask sheet 20 (in the present embodiment, positions overlapping left and right end portions of the nonwoven fabric sheet 30), and a pair of folded pieces 54 and 54 located outward of the pair of band pieces 53 and 53 in the left-right direction.

The upper band portion 57 and the lower band portion 58 are sewn respectively along upper and lower edge portions of the mesh material 60, and a lower edge portion 55 of the upper band portion 57 and an upper edge portion 56 of the lower band portion 58 are separated from the mesh material 60 to form openings 59a and 59b (see FIG. 4). Further, since the pair of band pieces 53 and 53 have a length in which an upper end portion and a lower end portion extend to upper and lower edge portions of the mesh material 60 and are sewn to the mesh material 60, upper end portions of the band pieces 53 and 53 overlap the upper band portion 57, and lower end portions of the band pieces 53 and 53 overlap the lower band portion 58, respectively. Further, the pair of folded pieces 54 and 54 are sewn to folded portions 61 of the mesh material 60 together with left and right end portions of the upper band portion 57 and the lower band portion 58, and are folded back and sewn together to form tubular folded portions 11. Accordingly, the mask main body portion 10 shown in FIG. 5 is completed.

In a state where the upper band portion 57 and the lower band portion 58 are in contact with the mesh material 60 to close the openings, as shown in FIG. 5, a first ventilation portion 51 is formed by a central portion of the mesh material, and a pair of second ventilation portions 52 and 52 are formed by lateral portions of the mesh material 60 adjacent to the first ventilation portion 51. That is, the fabric cloth 50 is sewn to the mesh material 60 so as to open the central portion serving as the first ventilation portion 51 and the pair of lateral portions serving as the pair of second ventilation portions 52 and 52. Then, the first ventilation portion 51 is defined by the upper band portion 57 and the lower band portion 58 of the fabric cloth 50 and the pair of band pieces 53 and 53. Further, the pair of second ventilation portions 52 and 52 are defined by the upper band portion 57, the lower band portion 58, the pair of band pieces 53 and 53, and the pair of folded portions 11 and 11, respectively.

The first ventilation portion 51 is opened in an area corresponding to a peripheral portion of a mouth or nostrils. Specifically, the first ventilation portion 51 has a width in the upper-lower direction that is substantially equal to an upper-lower dimension of the mask sheet 20, and a width in the left-right direction that is wider than a left-right dimension of the mask sheet 20 and is slightly narrower than a left-right dimension of the nonwoven fabric sheet 30. Further, the pair of second ventilation portions 52 and 52 are provided on left and right outer sides of left and right end portions of the nonwoven fabric sheet 30, and serve as passages for the wearer to breathes out on which the nonwoven fabric sheet 30 and the mask sheet 20 are not overlapped. Therefore, breathing becomes easy, and breath is prevented from remaining in the mask. The upper band portion 57 and the lower band portion 58 may have upper-lower dimensions that sandwich the nonwoven fabric sheet 30. Therefore, upper-lower dimensions of the first ventilation portion 51 and the second ventilation portions 52 and 52 can be increased (in the present embodiment, 50% or more of an upper-lower dimension of the mask main body portion 10), and the air permeability can be further improved. In the present embodiment, the upper band portion 57 and the lower band portion 58 of the fabric cloth 50 are integrally formed by sewing two left and right components, and the mesh material 60 is also integrally formed by sewing two left and right components.

A pair of ear straps 40 and 40 for fixing the mask main body portion 10 to ears of the wearer are connected to both left and right ends of the mask main body portion 10 in the drawing. The ear straps 40 and 40 are preferably made of loop-shaped or string-shaped stretchable materials. Examples of the stretchable material can include a union band of rubber yarn and cotton, an interwoven net of a resin filament, and a stretchable nonwoven fabric. The ear straps 40 and 40 are inserted into the tubular folded portions 11 formed by folding the sewn folded portions 61 of the mesh material 60 and the sewn band portions 54 of the fabric cloth 50, and are connected to the mask main body portion 10. The ear straps 40 and 40 may be attached by being sewn to at least one of the mesh material 60 and the fabric cloth 50.

Since the nonwoven fabric sheet 30 is in contact with lower portions of lips and the nose of the wearer, the nonwoven fabric sheet 30 has an action of improving attachment properties of the mask 1 and preventing droplets from the wearer from being discharged to an outside of the mask 1 through the ventilation portion 51 of the mask main body portion 10.

A dimension of the mask sheet 20 in the upper-lower direction has a size substantially equal to that of the first ventilation portion 51 in the upper-lower direction, but the nonwoven fabric sheet 30 needs to be sandwiched between the mesh material 60 and the fabric cloth 50, and thus has a dimension larger than that of the mask sheet 20 in the upper-lower direction, that is, larger than that of the first ventilation portion 51 of the mask main body portion 10 in the upper-lower direction. Further, the nonwoven fabric sheet 30 also has a dimension larger than that of the mask sheet 20 in the left-right direction in order to be bonded with double-sided tapes 80 described later.

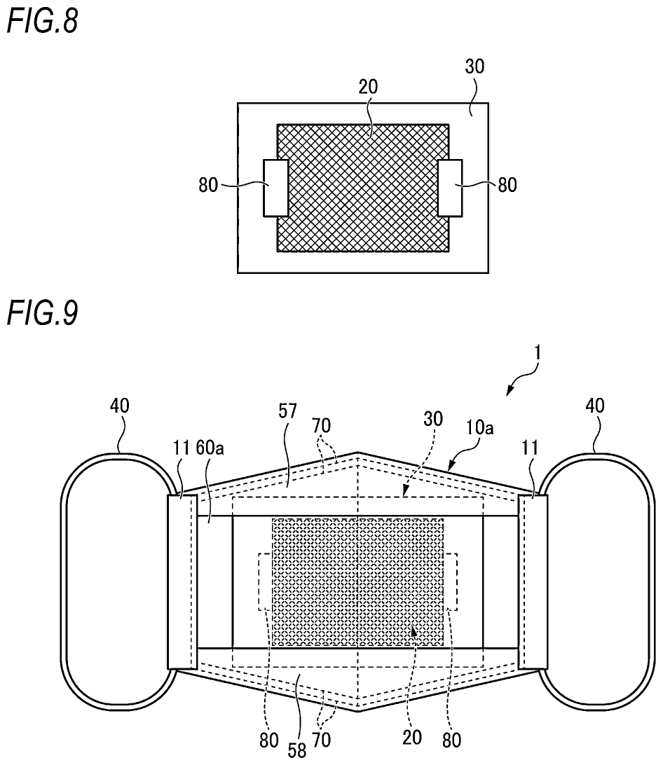

In the mask 1 having such a configuration, first, as shown in FIG. 8, the mask sheet 20 and the nonwoven fabric sheet 30 are fixed on one surface by the two double-sided tapes (adhesive tapes having adhesive surfaces on both surfaces) 80.

Next, with the upper and lower openings of the mask main body portion 10 open, upper and lower edge portions of the nonwoven fabric sheet 30 are inserted, the nonwoven fabric sheet 30 is sandwiched between the mesh material 60 and the upper band portion 57 and the lower band portion 58 of the fabric cloth 50, and the nonwoven fabric sheet 30 and the mask sheet 20 are fixed to the mask main body portion 10 by the other surfaces of the double-sided tapes 80. Accordingly, the mask 1 shown in FIG. 3 is completed. Therefore, the mask sheet 20, the nonwoven fabric sheet 30, and the mask main body portion 10 are relatively positioned, and a degree of attachment of the mask 1 is increased. Particularly, since the nonwoven fabric sheet 30 is fixed to the mask main body portion 10 at four positions of upper, lower, left, and right, it is possible to reliably prevent displacement of the mask sheet 20 and the nonwoven fabric sheet 30 with respect to the mask main body portion 10.

As described above, the mask sheet 20 and the mask main body portion 10 can be cleaned and repeatedly used. Specifically, after use, the double-sided tapes 80 are peeled off, the used nonwoven fabric sheet 30 is discarded, and in the same manner as described above, the mask sheet 20 and the mask main body portion 10 can be repeatedly used by using the new double-sided tapes 80 and the new nonwoven fabric sheet 30 and assembling the new double-sided tapes 80 and the new nonwoven fabric sheet 30 together with the cleaned mask sheet 20 to the mask main body portion 10.

As described above, according to the mask 1 of the present embodiment, the nonwoven fabric sheet 30 prevents the droplets from the wearer, the silver ions contained in the mask sheet 20 exhibit excellent disinfection, sterilization, anti-bacteria, and deodorant effects, and in the mask main body portion 10, the peripheral portions of the mouth and the nostrils of the wearer are covered with the mesh material 60, so that the mask 1 is excellent in air permeability and heat dissipation. Therefore, performance of the mask 1 is more excellent, and the mask 1 can also be favorably used for applications requiring the air permeability, particularly, use under a high temperature such as summer. Further, since the mask sheet 20 and the mask main body portion 10 can be cleaned and repeatedly used, it is economical. Particularly, by converting an odor substance adhered to the mask main body portion 10 into a compound by the silver ions of the mask sheet 20, it is also possible to deodorize the mask main body portion 10. Therefore, even when the mask main body portion 10 is not washed frequently, the mask main body portion 10 can be used continuously without worrying about odor.

Regarding the mask of the above-described embodiment, the mask 1 may be assembled by fixing only the mask sheet 20 and the nonwoven fabric sheet 30 with adhesive tapes having adhesive surfaces only on one surface, and simply sandwiching the nonwoven fabric sheet 30 between the upper band portion 57 and the lower band portion 58 and the mesh cloth 60 in the mask main body portion 10.

Further, the mask of the above-described embodiment is configured to include the first ventilation portion 51 and the pair of second ventilation portions 52 and 52, but the mask of the present invention may be configured to include only the first ventilation portion 51. Alternatively, the first ventilation portion 51 and the pair of second ventilation portions 52 and 52 may be configured to be continuously formed without including the pair of band pieces 53 and 53.

In the above-described embodiment, the fabric cloth 50 includes the upper band portion 57, the lower band portion 58, the pair of band pieces 53 and 53, and the pair of folded pieces 54 and 54, but the present invention is not limited thereto, and may be sewn to the mesh material 60 by opening the central portion of the mesh material 60 such that the first ventilation portion 51 is formed by the central portion of the mesh material 60.

In the above-described embodiment, the mask main body portion 10 uses the mesh material 60 as the outside cloth, but the present invention is not limited thereto. As shown in FIG. 9, the mask main body portion 10 may be formed of an outside cloth 60a other than the mesh material, such as another fabric cloth, a knitted fabric, a woven fabric, or a nonwoven fabric. Also in this modification, a mask main body portion 10a includes the outside cloth 60a, the fabric cloth 50 including the upper band portion 57 and the lower band portion 58 sewn to the outside cloth 60a so as to form the first ventilation portion 51 by a central portion of the outside cloth 60a and to vertically form the openings 59a and 59b for sandwiching the nonwoven fabric sheet 30 between the fabric cloth 50 and the outside cloth 60a, and the pair of ear straps 40 and 40 for fixing the mask main body portion 10 to the ears of the wearer. Further, the mask sheet 20 is a mesh sheet provided by knitting a twisted yarn in a mesh shape, the twisted yarn being provided by twisting filaments formed by coating synthetic fibers with silver, and is overlapped with the first ventilation portion 51.

Accordingly, the nonwoven fabric sheet 30 prevents droplets from the wearer, silver ions contained in the mask sheet 20 exhibit excellent disinfection, sterilization, anti-bacteria, and deodorization effects, and the mask main body portion 10 sandwiches the nonwoven fabric sheet 30 between upper and lower openings, so that the nonwoven fabric sheet 30 and the mask sheet 20 can be easily incorporated. Therefore, performance of the mask is more excellent, and the mask sheet 20 and the mask main body portion 10 can be cleaned and repeatedly used, which is economical.

(Other Masks)

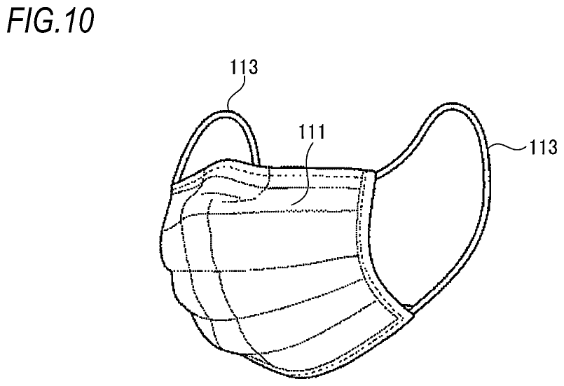

A mask shown in FIG. 10 includes a mask main body portion 111 including the above-described mask sheet 20 (not shown in FIG. 10), and ear straps 113 that are connected to the mask main body portion 111 and serve as fixing portions for fixing the mask main body portion 111 to a lower portion of a face of the wearer. The ear strap 113 is preferably made of a loop-shaped or string-shaped stretchable material. Examples of the stretchable material can include a union band of rubber yarn and cotton, an interwoven net of a resin filament, and a stretchable nonwoven fabric.

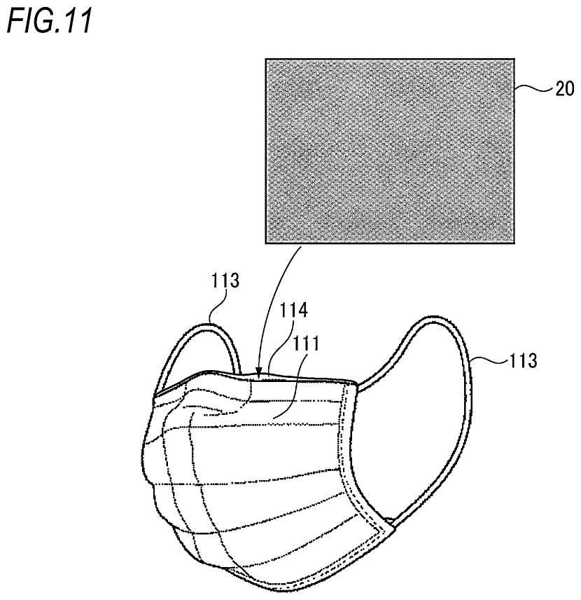

The mask main body portion 111 is formed by surrounding the mask sheet 20 with nonwoven fabrics or gauze. For example, as shown in FIG. 11, both side end portions and a lower end portion (one of upper and lower end portions) of two nonwoven fabrics (an outside sheet and an inside sheet) having substantially the same size may be joined to the mask main body portion 111 by welding or the like, a pocket portion 114 having upper end portions (the other of the upper and lower end portions) of the two nonwoven fabrics as an opening may be formed of two nonwoven fabrics, and the mask sheet 120 may be inserted from the opening of the pocket portion 114. Alternatively, the two nonwoven fabrics may form the pocket portion 114 into which the mask sheet 20 can be inserted from the opening of the upper end portion and the lower end portion by joining both side end portions thereof. Further, the mask sheet 20 may be used alone, but a sheet having, for example, an aromatic action or a moisturizing action may be laminated as necessary. Further, the mask main body portion 111 preferably has fold lines capable of forming a pleated three-dimensional shape. Such a fold line is formed in a pleat shape on the mask main body portion 111, and the shape is maintained at end portions by joining the both side end portions. That is, the fold lines are prevented from being unfolded at joint portions of the both side end portions, and the fold lines are unfolded during attachment in an intermediate region located between the both side end portion regions, so that pleats of the mask main body portion 111 are expanded to form the three-dimensional shape. When the mask is not attached, the pleat can be formed in a flat shape in which the pleat is closed and is not bulky.

The present invention is not limited to the above-described embodiment, and modifications, improvements, and the like can be made as appropriate.

This application is based on the Japanese utility model registration application filed on Feb. 28, 2020 (Japanese Utility Model Application 2020-000699) and the Japanese patent application filed on Jun. 30, 2020 (Japanese Patent Application No. 2020-113219), and contents of which are incorporated herein by reference.

### REFERENCE SIGNS LIST

1: mask
10, 10a, 111: mask main body portion
20: mask sheet
21: twisted yarn
30: nonwoven fabric sheet
40, 113: ear strap (fixing portion)
50: fabric cloth
51: first ventilation portion
52: second ventilation portion
59a, 59b: opening
60: mesh material
60a: outside cloth
80: double-sided tape

1. A mask sheet, wherein
the mask sheet is a mesh sheet in which twisted yarns are knitted into a mesh shape, the twisted yarns being provided by twisting filaments each of which is formed by coating a synthetic fiber with silver.

2. The mask sheet according to claim 1, wherein
a stitch opening of the mesh sheet is 1 mm or more.

3. The mask sheet according to claim 1, wherein
the mesh sheet is a tricot-knitted sheet.

4. A mask for covering a peripheral portion of a mouth and nostrils of a wearer, wherein
the mask comprises a nonwoven fabric sheet, the mask sheet according to claim 1, and a mask main body portion in this order from a face side of the wearer,
the mask main body portion includes a mesh material having a stitch opening of 1 mm or more, a fabric cloth sewn to the mesh material so as to open a central portion of the mesh material such that a first ventilation portion is formed by the central portion of the mesh material, and a pair of ear straps for fixing the mask main body portion to ears of the wearer, and
the mask sheet is overlapped with the first ventilation portion.

5. The mask according to claim 4, wherein
the fabric cloth is sewn to the mesh material so as to open lateral portions of the mesh material to form a pair of second ventilation portions by the lateral portions of the mesh material adjacent to the first ventilation portion in a left-right direction, and
the second ventilation portions are located on left and right outer sides of left and right end portions of the nonwoven fabric sheet.

6. The mask according to claim 5, wherein
the fabric cloth includes a pair of band pieces that are sewn to the mesh material and separate the first ventilation portion and the second ventilation portions.

7. The mask according to claim 4, wherein
the nonwoven fabric sheet having a rectangular shape is larger than the mask sheet having a rectangular shape, and
the fabric cloth includes an upper band portion and a lower band portion which are sewn to the mesh material so as to form an opening to sandwich the nonwoven fabric sheet between the mesh material and the fabric cloth.

8. The mask according to claim 4, further comprising:
a double-sided tape that fixes the nonwoven fabric sheet and the mask sheet by one surface and that fixes the nonwoven fabric sheet and the mask sheet to the mask main body portion by the other surface.

9. A mask for covering a peripheral portion of a mouth and nostrils of a wearer, wherein
the mask comprises a nonwoven fabric sheet, the mask sheet according to claim 1, and a mask main body portion in this order from a face side of the wearer,
the mask main body portion includes an outside cloth, a fabric cloth having an upper band portion and a lower band portion sewn to the outside cloth so as to form a first ventilation portion by a central portion of the outside cloth and to form an opening for sandwiching the nonwoven fabric sheet between the fabric cloth and the outside cloth, and a pair of ear straps for fixing the mask main body portion to ears of the wearer, and
the mask sheet is overlapped with the first ventilation portion.

10. A mask main body portion for a mask for covering a peripheral portion of a mouth and nostrils of a wearer in cooperated together with the mask sheet according to claim 1 and a nonwoven fabric sheet, the mask main body portion comprising:
a mesh material having a stitch opening of 1 mm or more;
a fabric cloth sewn to the mesh material to form a first ventilation portion in a central portion of the mesh material; and
a pair of ear straps for fixing the mask main body portion to ears of the wearer.

11. A mask comprising:
a mask main body portion including the mask sheet according to claim 1; and
a fixing portion connected to the mask main body portion and configured to fix the mask main body portion to a lower portion of a face of a wearer.

12. The mask according to claim 11, wherein
the mask main body portion includes a pocket portion for inserting the mask sheet.
